(19) United States
(12) Patent Application Publication
(10) Pub. No.: US 2014/0376885 A1
(43) Pub. Date: Dec. 25, 2014

(54) METHOD FOR PLAYING VIDEO FILE AND ELECTRONIC DEVICE USING THE SAME

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: HAI-SHENG LI, Shenzhen (CN); CHIH-SAN CHIANG, New Taipei (TW); GANG TANG, Shenzhen (CN); XIAO-MAN PU, Shenzhen (CN)

(21) Appl. No.: 14/306,239

(22) Filed: Jun. 17, 2014

(30) Foreign Application Priority Data
Jun. 20, 2013 (CN) 201310244163X

(51) Int. Cl. G11B 27/30

(52) U.S. Cl. CPC G11B 27/30
USPC 386/241

(57) ABSTRACT

A method for playing audio out of a video file includes the following steps. Open a video file stored in a storage unit. Decode the opened video file. Separate the video file into video data and audio data wherein the audio data comprises a plurality of pieces of music data. A starting position and an ending position of each piece of music data is established and recorded by reference to the spectral characteristics. All indexed passages of music data are then playable according to the recorded starting and ending positions. An electronic device using the same is also provided.

### FIELD

The present disclosure relates to video technology, especially to a method for playing video files and electronic device using the same.

### BACKGROUND

Video files can include video data and audio data. Audio data can include voice data and music data. For example, a film can include at least one portion of music data. A user who wishes to hear again one particular piece of music can choose to play one portion of the music data by fast forwarding or fast reversing the music data.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the drawings.

FIG. 1 illustrates a block diagram of an embodiment of an electronic device.

FIG. 2 is a flowchart of an embodiment of a method for playing video files.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”. The references “a plurality of” and “a number of” mean “at least two.”

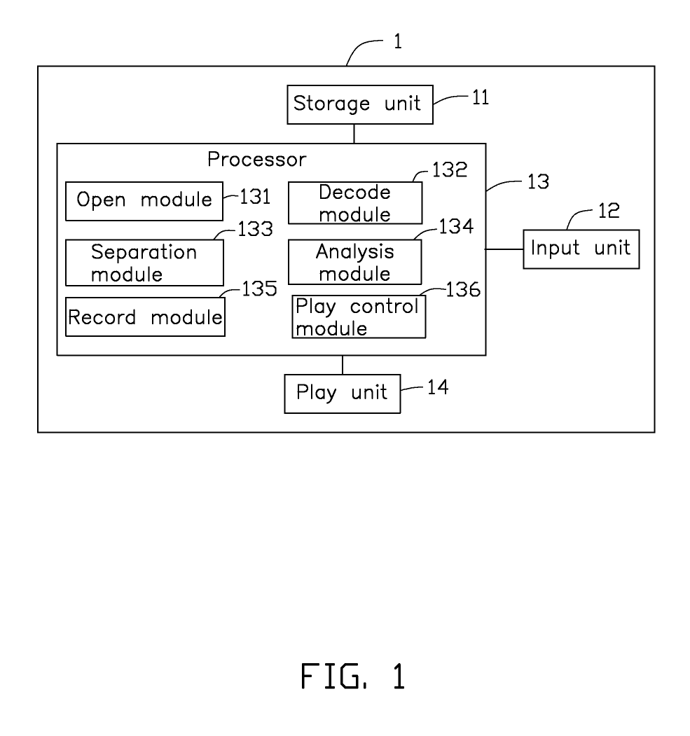

FIG. 1 illustrates a block diagram of an embodiment of an electronic device 1. The electronic device 1 has a function for playing video files. The electronic device 1 can be a personal computer, a telephone, a tablet personal computer, or other electronic device.

The electronic device 1 can include a storage unit 11, an input unit 12, a processor 13, and a playback unit 14.

The storage unit 11 stores at least one video file. The video file can include video data and audio data. The audio data can include voice data and music data.

The input unit 12 generates a signal in response to a user's operation applied thereon. In at least one embodiment, the user's operation can be an operation for opening a video file, playing the video file, playing a next video file, playing a previous video file, or other operation.

The processor 13 can include an open module 131, a decode module 132, a separation module 133, an analysis module 134, a record module 135, and a play control module 136.

The open module 131 is used for opening a video file stored in the storage unit 11.

The decode module 132 is used for decoding the opened video file.

The separation module 133 is used for separating the decoded video file into video data and audio data. The audio data can include a number of pieces of music data and a number of pieces of voice data.

The analysis module 134 is used for analyzing a starting position and an ending position of each piece of the music data of the audio data according to the spectral characteristic of the audio data as the spectral characteristic of the music data and the voice data is different.

The recording module 135 is used for recording the starting position and the ending position of each piece of the music data of the audio data, and storing the recorded starting position and the ending position of the music data of the audio data in the storage unit 11.

The play control module 13 is used for controlling the playback unit 14 to play the video file in response to a user's operation of playing the video file. The play control module 136 is further used for controlling the playback unit 14 to play the music data according to the recorded starting position and ending position of the music data of the audio data in response to a user's operation for playing the music data whose starting position and ending position has been recorded. In the embodiment, the first played piece the music data is of the music data with first starting and ending positions recorded.

After the first piece recorded music data has been played, the play control module 136 further determines whether there is another piece of recorded music data to be played, and if so controls the playback unit 14 to play the next piece of the recorded music data.

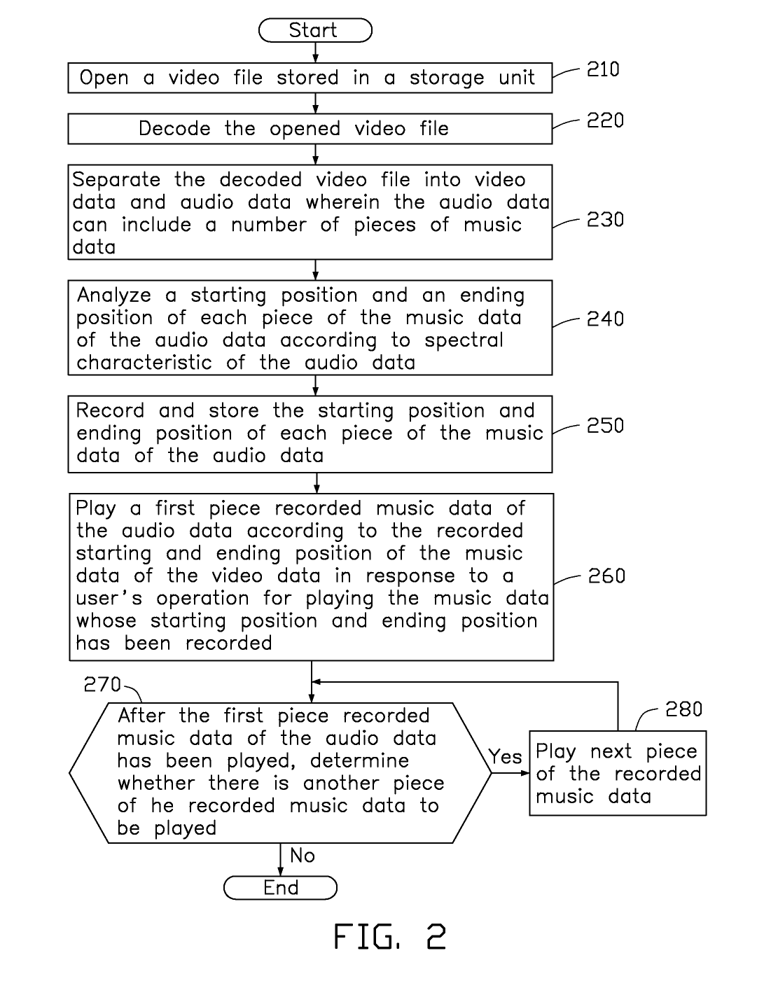

FIG. 2 is a flowchart of an embodiment of a method for playing video files.

In block 210, the open module opens a video file stored in the storage unit.

In block 220, the video decode module decodes the opened video file.

In block 230, the separation module separates the decoded video file into video data and audio data. In at least one embodiment, the audio data can include a number of pieces of music data.

In block 240, the analysis module analyzes the starting position and the ending position of each piece of the music data of the audio data according to the spectral characteristic of the audio data.

In block 250, the recording module records the starting position and the ending position of each piece of the music data of the audio data, and stores the recorded starting position and the ending position of each piece of the music data of the audio data in the storage unit.

In block 260, the play control module controls the playback unit to play the first piece recorded music data according to the recorded starting ending positions of the music data of the audio data in response to a user's operation for playing music data of which the starting and ending positions has been recorded.

In block 270, after the first piece recorded music data of the audio data has been played, the play control module determines whether there is another piece of the recorded music data of the audio data to be played, if yes, the process goes to block 280, otherwise, the process ends.

In block 280, the play control module controls the playback unit to play the next piece of the recorded music data, then the process goes to block 270.

Although the present disclosure has been specifically described on the basis of various embodiments thereof, the disclosure is not to be construed as being limited thereto. Various changes or modifications may be made to the embodiments without departing from the scope of the disclosure. The embodiments described herein are illustrative and should not be construes to limit the scope of the following claims.

What is claimed is:

1. An electronic device, comprising:
a storage unit to store a plurality of video files;
a playback unit;
a processor comprising:
an open module to open a video file stored in the storage unit;
a video decode module to decode the opened video file;
a separation module to separate the video file into video data and audio data, the audio data comprising a plurality of pieces of music data;
an analysis module to analyze a starting position and an ending position of each piece of each piece of the music data of the audio data;
a recording module to record and store the starting position and the ending position of each piece of the music data of the audio data;
a play control module to control the playback unit to play the music data according to the recorded starting position and the ending position of the music data of the audio data.

2. The electronic device as described in claim 1, wherein the starting position and the ending position of each piece of music data of the audio data are analyzed according to spectral characteristic of the audio data.

3. The electronic device as described in claim 1, wherein the first played piece of the recorded music data is a first piece of the recorded music data.

4. The electronic device as described in claim 3, wherein after the first piece recorded music data of the audio data has been played, the play control module is further configured to determine whether there is another piece of the recorded music data of the audio data to be played, and controls the playback unit to play next piece of the recorded music data when there is another piece of the recorded music data of the audio data to be played.

5. A method for playing video, comprising:
opening a video file stored in a storage unit;
decoding the opened video file;
separating the video file to video data and audio data wherein the video data comprises a plurality of pieces of music data;
analyzing a starting position and an ending position of each piece of music data of the audio data;
recording and storing the starting position and the end position of each piece of the music data of the audio data;
playing the music data according to the recorded starting and ending position of the music data of the audio data.

6. The electronic device as described in claim 5, wherein the starting and ending position of each piece of music data of the audio data are analyzed according to spectral characteristic of the audio data.

7. The electronic device as described in claim 5, wherein the first played piece of the recorded music data is a first piece of the recorded music data.

8. The electronic device as described in claim 7, comprising determine whether there is another piece of the recorded music data of the audio data to be played after the first piece recorded music data of the audio data has been played;
play next piece of the recorded music data when there is another piece of the recorded music data to be played.
